(19) United States
(12) Patent Application Publication
(10) Pub. No.: US 2013/0286211 A1
(43) Pub. Date: Oct. 31, 2013

(54) Method and apparatus for live capture image-live streaming camera utilizing personal portable device

(71) Applicant: Jianhua Cao, Walnut, CA (US)

(72) Inventor: Jianhua Cao, Walnut, CA (US)

(21) Appl. No.: 13/506,547

(22) Filed: Apr. 26, 2012

(51) Int. Cl. H04N 7/18

(52) U.S. Cl. 348/159; 348/E07.085

(57) ABSTRACT

A method for transferring live images includes the steps of capturing live image information by one or more live image devices, wherein the live image information is continuously transferred to one or more server centers in a live manner; communicatively linking the server centers to a control center in order to manage the live image information at the server centers; and communicatively linking one or more personal portable devices to the server centers through a wireless communication network to selectively live-broadcast the live image information to the personal portable devices.

### BACKGROUND OF THE PRESENT INVENTION

1. Field of Invention

The present invention relates to a method and apparatus for image capture, and more particularly to a live image capture device which output is directly accessible by users via any personal portable device such as smart phone or tablet computer.

2. Description of Related Arts

Live image capture devices, commonly known as cameras, are used to record images. These images can then be perused in situations with a different time and place than where the image was taken. Because of these benefits and the advances in technology that have made cameras ubiquitous and available to most of the general public, cameras are widely used in modern society.

An example of the prevalence of cameras is the wide usage of cameras for security by both public and private institutions. In a scenario where an area needs to be continuously be monitored, cameras are often more suited for the job than humans, since images are recorded onto a hard medium and are viewable by others as long as the medium is maintained.

However, a camera by itself will most likely have just one function—capturing the image. One or more controllers must be employed to collect the data that is produced by the camera. In complex systems involving a multitude of cameras, the amount of resources required to maintain such a system increases significantly, and thus places limits on the efficiency of the system based on the available resources of the system's operator.

In such a system, high costs are accrued through the installation of the system itself. In a typical operation involving the installation of the system, the controller needs to be installed and secured. Then, the cameras themselves need to be installed in their respective positions, and a path of data transfer must be established between the cameras and the controller. Then, the interface of the system needs to be modified and adjusted to suit the operator's specifications, and so forth. This system cannot be very easily modified, and thus is limited in terms of flexibility.

The application of such systems is also limited by the medium upon which data is exchanged between the cameras and the controllers. Many existing camera-controller systems utilize wired networks in order to transfer data between the two. A well-known example of this is CCTV, where a signal from a camera is not openly transmitted, but broadcast to authorized controllers within the system. More modern systems employ Ethernet networks, such as the Internet, to transfer data.

Using the Internet protocol is highly advantageous, since most electronic devices today can in some way interact with this method of data transfer. However, the rate of data transfer in current systems is bottlenecked by the physical layer of the network infrastructure provided by the network service provider. An example of this is the fact that the current most popular network carriers, DSL and Internet cable, are only capable of uploading 1.5 Mb/s at maximum, which is hardly enough to transfer a high quality, high resolution video stream without delay.

A conventional way of solving this problem has been the act of video compression. This method has been widely used, but is not without its drawbacks. First, in order to compress video images transmitted by a camera, developers must create algorithm and codes for compression. This results in the creation of a plethora of compression codes, most incompatible with each other, in the market today.

Even when compression codes are relatively similar, minor differences in compression code from different providers can result in incompatibility. Consumers wishing to view electronic media must often face the daunting task of finding the correct decoding codec to match the code that the media was compressed with.

Another issue is currently used live video format is not editable. It is difficult to edit the display when the image is displayed lively.

In addition, portable electronic devices, such as smart phone or tablet computer, become a personal assistant and are very handy communications tools. Most portable electronic devices are also Internet-based devices adapted to wirelessly link to a particular camera, such as an IP camera. Therefore, the user is able to view the image being captured by that particular camera. In other words, the portable electronic device and the camera are linked to form a one-to-one network. Since the image format of the camera may not be compatibility with the software of the portable electronic device, the image from the camera may not be properly displayed on the camera. In other words, different portable electronic devices require different software to display the image.

Therefore, the camera must be pre-configured to a particular format in order to transmit and display on the portable electronic device. In addition, the portable electronic device cannot link to a plurality of cameras at different locations.

Regarding the issues relating to current methods of image capture and transfer, there appears to be a need for the direct capture and transfer of images through a network.

### SUMMARY OF THE PRESENT INVENTION

The invention is advantageous in that it provides a method and apparatus for the live capture of images and the direct transfer of the aforementioned electronically through an Internet network in order to transmit to a personal portable device, such as a smart phone or a tablet computer.

Another advantage of the invention is to a live image capture device which output is directly accessible by users via any personal portable device such as smart phone or tablet computer.

Another advantage of the invention is to a live image capture system, wherein the personal portable device is able to link to different live image devices at different locations.

Another advantage of the invention is to a method and apparatus for an image capture device that is accessible in real-time to the personal portable device.

Another advantage of the invention is to a live image capture system, which is easy to connect the personal portable device with a network to transmit the image therefrom.

Another advantage of the invention is to a live image capture system, which doesn't does not require a separate controller.

Another advantage of the invention is to a method and apparatus for live capture image which is easy to install into the personal portable device.

Another object of the present invention is to provide a method and apparatus for live capture image which reduces the required resources to install the method and apparatus itself.

Another object of the present invention is to provide a method and apparatus for live capture image which is remote controllable.

Another object of the present invention is to provide a method and apparatus for live capture image which supports simultaneous viewing of multiple channels.

Another object of the present invention is to provide a method and apparatus for live capture image which provides high quality live images.

Another object of the present invention is to provide a method and apparatus for live capture image which reduces the amount of required storage media to hold output data.

Additional advantages and features of the invention will become apparent from the description which follows, and may be realized by means of the instrumentalities and combinations particular point out in the appended claims.

According to the present invention, the foregoing and other objects and advantages are attained by a method for transferring live images, comprising the steps of:

(a) capturing live image information by one or more live image devices, wherein the live image information is continuously transferred to one or more server centers in a live manner;

(b) communicatively linking the server centers to a control center in order to manage the live image information at the server centers; and

(c) communicatively linking one or more personal portable devices to the server centers through a wireless communication network to selectively live-broadcast the live image information to the personal portable devices.

In accordance with another aspect of the invention, the present invention comprises a live image system for transferring live images to personal portable devices, comprising:

one or more live image devices located at different locations for capturing live image information;

one or more server centers communicatively linked to the live image devices for receiving the live image information from the live image device, wherein the live image information is continuously transferred to the respective server center in a live manner; and

a control center communicatively linked to the server centers in order to manage the live image information at the server centers, wherein each of the server centers is arranged for communicatively linking the personal portable devices through a wireless communication network to selectively live-broadcast the live image information to the personal portable devices.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a live capture image-live streaming system according to a preferred embodiment of the present invention.

FIG. 2 illustrates the personal portable device directly linked to the server center through the web browser of the personal portable device according to the above preferred embodiment of the present invention.

FIG. 3 illustrates the personal portable device directly linked to the server center through the compatible application according to the above preferred embodiment of the present invention.

FIG. 4 is a flow chart illustrating the method of transferring live images to the personal portable device according to the above preferred embodiment of the present invention.

### DETAILED DESCRIPTION OF THE PREFERRED EMBODIMENT

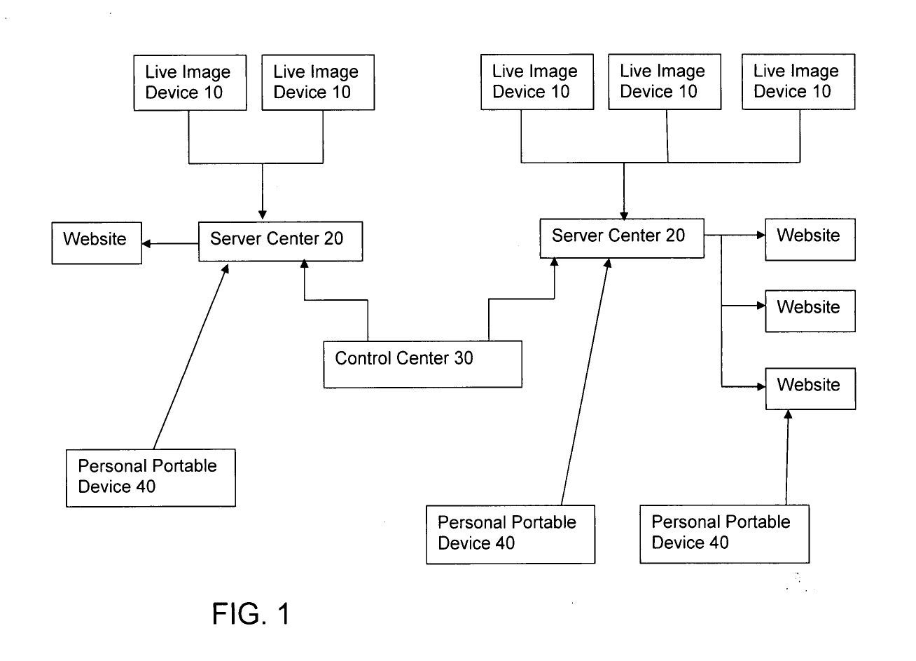

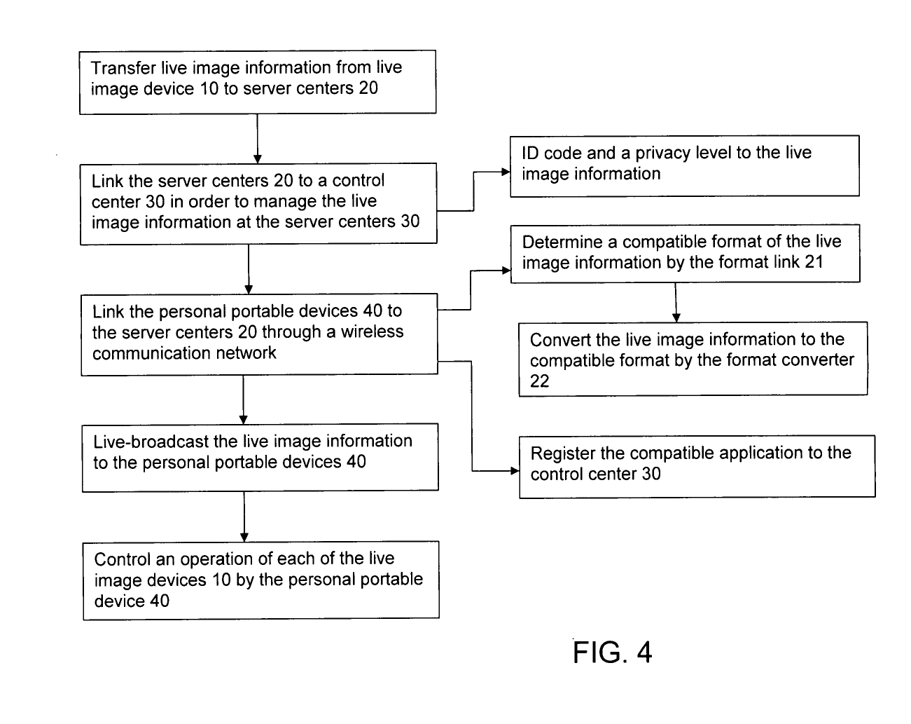

Referring to FIGS. 1 and 4, a method and system for transferring live images is illustrated, wherein the system of the present invention comprises one or more live image devices 10, one or more server centers 20, and a control center 30.

Each of the live image devices 10 is adapted for securely mounting at a predetermined location to capture live image information and converts the captured live image information into electronic signals. Preferably, the image capture device 10 comprises a lens to capture light waves from a predetermined area, and an optical sensor to convert the light waves into electronic signals. The electric signals can be transferred and processed later to reproduce the image by display devices, such as a computer monitor. Accordingly, the live image device 10 is able to work normally in a large range of environment.

The image can be captured in different manners for different purposes. The live image device 10 may take snapshot, which means capturing only one slide of image in a predetermined period of time. The live image device 10 may take video, which means capturing a serial of slides of image in a short period of time, or in other words, taking snapshots continuously and frequently with short snapshot interval. Depending on the requirement, the live image device 10 is able to provide different numbers of slides of image with different intervals.

Many techniques are appreciated to be applied in the live image device 10 by whom skilled in the art. The embodiment of the present invention preferably utilizes but not limited to CCTV (Closed Circuit Television). In an alternative embodiment of the present invention, the apparatus for live capture image comprises more than one image capture devices to provide multiple channels of images. Therefore the user can accept multiple images simultaneously or alternatively.

Each of the server centers 20 can linked by wire or wirelessly to more than one live image devices 10. In particular, the server centers 20 are communicatively linked to the live image devices 10 for receiving the live image information from the live image device 10, wherein the live image information is continuously transferred to the respective server center 20 in a live manner. In addition, each of the server centers is arranged for communicatively linking the personal portable devices 40 through a wireless communication network to selectively live-broadcast the live image information to the personal portable devices 40. Accordingly, the personal portable device 40 can be a smart phone or tablet computer such as “iphone” or “ipad” using “ISO operation system”, or “Android” phone or “Android tablet” using “Android operating system”.

According to the preferred embodiment, the user is able to view any one of the live image information anywhere through Internet. For example, the user is able to use personal computer with its operation system such as “Window®”, “Linux®”, or Mac®, to access one or more of the live image devices 10 in order to view the live image information. In addition, the user is able to use the personal portable device 40, such as smart phone or tablet computer, to view the live image information.

As it is mentioned above, the live image device 10 is adapted to capture image information and converts the captured image information into electronic signals. Accordingly, the live image information is captured by the live image device 10 in H.264 video raw streaming format. Preferably, each of the live image devices 10 comprises a surveillance camera with built-in IP address for capturing the live image information and an encoder processor operatively linked to the surveillance camera for encoding the live image information in H.264 video raw streaming format.

When the live image information is cloned at the server center 20, the live image information is converted from the raw format into the viewable format and an embed code is generated corresponding to the live image information at the same time. Preferably, the server center 20 comprises a code generator for generating the embed code at the same time when the live image information is converted and cloned at the server center 20.

When the live image information is captured by the live image device 20A, the live image information is transferred to the server center 20 in RTSP (Real Time Streaming Protocol) form. Accordingly, the live image information is transferred to the server center 20 through TCP/UDP before and after the live image information is converted at the server center 20. In other words, after the conversion, the live image information can be viewed by any web-based browser. In particular, the live image information will be transformed into the RTMP (Real Time Messaging Protocol) form. It is worth mentioning that the live image information in different video formats can be transferred to the server center 20 and can be converted into different video formats by the server center 20 selected by the user.

At the same time, the embed code is also generated concurrently by the code generator. The embed code is a html source code being uniquely generated in response to the live image device 10 and the server center 20. For example, when the live image information is captured by one live image device 10 and is transferred to two different server center 20, two different embed codes will be generated at the two server centers 20. Likewise, when two different live image information are captured by two different live image devices 10 and are transferred to one server center 20, two different embed codes will be generated at the server center 20 with respect to the two different live image devices 10. Therefore, the embed code is a unique code corresponding to the live image device 10 and the server center 20.

Once the embed code is generated, one or more users are enabled to use the embed code in order to broadcast the live image information over any website without any proprietary software. In particular, the embed code is a text code adapted to “copy-and-paste” to the website to link the live image information from the server center 20 to the website, especially the personal website of the user, so as to live-stream the live image information from the live image device 10 to the personal website. It is worth mentioning that when the embed code is inputted at the website, the website will automatically link to the server center 20 to broadcast the live image information therefrom.

The control center 30 is communicatively linked to the server center 20 preferably by Internet. In particular, the control center 30 is a web-based station wirelessly linked to the server center 20. Accordingly, the control center 30 provides an activation code to the server center 20 for activating the live image device 10 in order to transfer the live image information from the live image devices 10 to the server centers 20 in a live manner. In other words, without the activation code, the live image information will not be transferred from the live image device 10 to the server center 20.

The control center 30 comprises an initializing center for setting each of the live image devices 10, wherein the initializing center contains the activation code for identifying the corresponding live image device 10 to the server center 20, and an input of an IP address of one of the live image devices 10 for identifying the location thereof.

Before accessing the server center 20, the present invention preferably comprises the following installation steps.

(I) Install the live image device 10, i.e. for personal use, setting up the IP address of the live image device 10 and RTSP port, wherein the IP address of the live image device 10 can be set as “192.198.1.201” as an example, and the RTSP port can be set as 554 as an example. In the step (I), when the live image device 10 is set up through a local area network (LAN), the server or personal computer will find the location of the live image device 10 through a locator once the live image device 10 is connected to a router through the local area network (LAN). Therefore, the information of the IP address, the port, device type, subnet mask, default gateway, and port forward corresponding to the live image device 10 will be displayed on the server center 20.

(II) Install accessing software as the server center 20 at the server or personal computer including inputting the activation code and the IP address of the live image device 10 in order to access the live image device 10, wherein the software structures includes an executable binary file of the server center 20, a media player of the server center 20, and a live.html which is a webpage of checking video streaming and script code generated by the server center 20. The live.html file includes an embed source having the code of the designated live image device 10 as the embed code. In the step (II), by downloading the software from the control center 30 to the server or personal computer, the server center 20 will be set up in the server or personal computer. The user is able to input the above information of the live image device 10 through the set up process, such as inputting the activation code and the IP address of the live image device 10.

(III) Login the control center 30 to configure the live image device 10. In the step (III), the user, i.e. the owner of the live image device 10, is able to login the control center 30 in order to configure the live image device 10. In the step (III), the user is able to obtain the embed code from the control center 30, wherein the user is able to copy the embed code from the control center 30 to his or her personal website for broadcasting the live image information. It is worth mentioning that the user is able to view the live image information at the control center 30 as well to configure the live image device 10. In addition, having the embed code can be used as the source code for sharing the live image information. It is worth mentioning that the embed code forms a shortcut for the user to broadcast the live image information. No other software or particular command is required for the user to set up his or her personal website to link with the live image device 10. Once the embed code is placed, by pasting the text code of the embed code, the live image information will be automatically displayed on the personal website.

It is worth mentioning that the control center 30 can track the live image information through the embed code. In particular, the control center 30 is able to keep track which server center 20 being used for broadcasting the live image information because the embed code is placed to the server center 20. In addition, the control center 30 is able to obtain the numbers of viewers viewing the live image information from the server center 20. Therefore, the numbers of viewers will be shown in the control center 30 to illustrate how many times the live image information from the live image device 10 being viewed from the particular server center 20. In addition, the control center 30 further provides a comment list placed below the live image information display for the viewers to leave any comment regarding the live image information. The control center 30 will control the comments left by the viewers when any junk or impolite comment is left, the control center 30 will remove such comment from the comment list and will prohibit any comment being left by the corresponding viewer.

Accordingly, two or more of the live image devices 10 can be linked together through the server center 20 to establish a network, wherein each of the live image devices 10 is adapted for being accessed through the server center 20 by the user to view the corresponding live image information. In other words, the user is able to access the server center 20 in order to select one or more live image devices 10 to view the live image information.

It is worth mentioning that the user is able to install the server center 20 into his or her server or personal computer that the user of the server or personal computer is able to obtain the activation code from the control center 30. Once the input of the activation code, server center 20 is automatically linked to the corresponding live image device 10 to receive the live image information.

Each of the live image information is managed and indexed by the control center 30 that an ID code and a privacy level are assigned and configured by the control center 30 to each of the live image information at the server center 20.

Accordingly, the ID code is assigned by the control center 30 to identify the live image information captured from the corresponding live image device 10 and located at the corresponding server center 20. The ID code is different from the activation code, wherein the ID code of the live image information is shown at the server center 20 to illustrate the information of the live information such as the owner of the live image information, the location of the live information, and the number of viewers. Therefore, the user of the personal portable device 40 is able to select one of the live image information via the ID code at the server center 20 in order to live-broadcast the live image information at the personal portable device 40 through the wireless communication network. Accordingly, the wireless communication network can be “Wi-Fi”, 3G, 4G, or “EDGE” provided by the mobile communication provider.

The privacy level of the of the live image information is configured between a public mode that all of the live image information are accessible to be broadcasted on the personal portable device 40, and a private mode that the live image information is accessible to be broadcasted in an authorized manner.

The user, i.e. the owner of the live image device 10 is able to set the live image device 10 between the private mode and the public mode through the control center 30. For example, when the live image device 10 is set to capture the image of the retail store, the user is able to set the live image device 10 at the public mode, such that other users are able to view the live image of the retail store through the owner's website. When the live image device 10 is set to capture the image of the store's entrance as the security camera, the user is able to set the live image device 10 at the private mode. Therefore, only authorized users, such as security guard, can view the live image from the live image device 10. It is worth mentioning that an authorized code will be given by the control center 30 to the authorized users upon the request from the owner of the live image device 10.

In addition, the owner of the live image device 10 is able to select the private mode and the public mode of the live image information during the configuration of the live image device 10. When the live image information is set at the public mode, all users of the personal portable device 40 can view the live image information thereat.

The control center 30 provides a selection interface for allowing the user to select multiple live image devices 10 to view more than one live image information. Accordingly, all the live image devices 10 are shown in the selection interface. However, only the authorized user can access the live image devices 10 at the private mode. In other words, the authorized user can access the live image devices 10 in response to the authorized code from the control center 30. In order to set the live image device 10 at the private mode, the user is able to select the corresponding live image device 10 as an authorized manner such that other users cannot access the authorized live image device 10 without any permission. Other users can access the authorized live image device 10 by invitation of the authorized user.

It is worth mentioning that the users, including the owners of the live image device 10 and the visitors of the server centers 20, should register to the control center 30 to create a personal profile. The owners of the live image device 10 will create the personal profile including the configuration of the live image device 10 between the private mode and the public mode through the control center 30. The visitor can create the personal profile as a registered user to select one or more live image information as the default live image information for easy access. Once the registering steps are completed, the control center 30 will provide the user with the user name and password.

All users, including the owners of the live image device 10 and the registered users of the server centers 20, can always re-configure the personal profile through the control center 30.

Since different personal portable devices 40 use different software to view the live image information, the present invention is able to transform the live image information at the server center 20 into any compatible format.

According to the preferred embodiment, each of the server centers 20 comprises a format link 21 for determining a compatible format of the live image information being supported by the respective personal portable device 40, and a format converter 22 for converting the live image information in RTSP format to the compatible format in order to broadcast the live image information on the personal portable device 40. When the personal portable device 40 is linked to the server center 20 through the wireless communication network, the format link 21 will identify the type of the personal portable device 40 and the supporting format of the live image information. Once the live image information is selected to be live-broadcasted, the live image information will be automatically converted to the compatible format. Accordingly, the live image information can be converted into “Adobe Flash” format, “MOV”, “MP4”, “AVI” or the like.

It is worth mentioning that the format link 21 can automatically identify the type of the personal portable device 40 and the supporting format of the live image information. It is appreciated that a device selection can be provided at the server center 20 such that the user is able to select the device selection corresponding to the personal portable device 40.

According to the preferred embodiment, there are two ways for the personal portable devices 40 to access the live image information at the server center 20. The first way is that each of the server centers 20 is accessible through a web browser of the personal portable device 40 in order to broadcast the live image information to the web browser of the personal portable device 40. The second way is that the personal portable device 40 is directly linked to the respective server center 20 via a compatible application downloaded to the personal portable device 40.

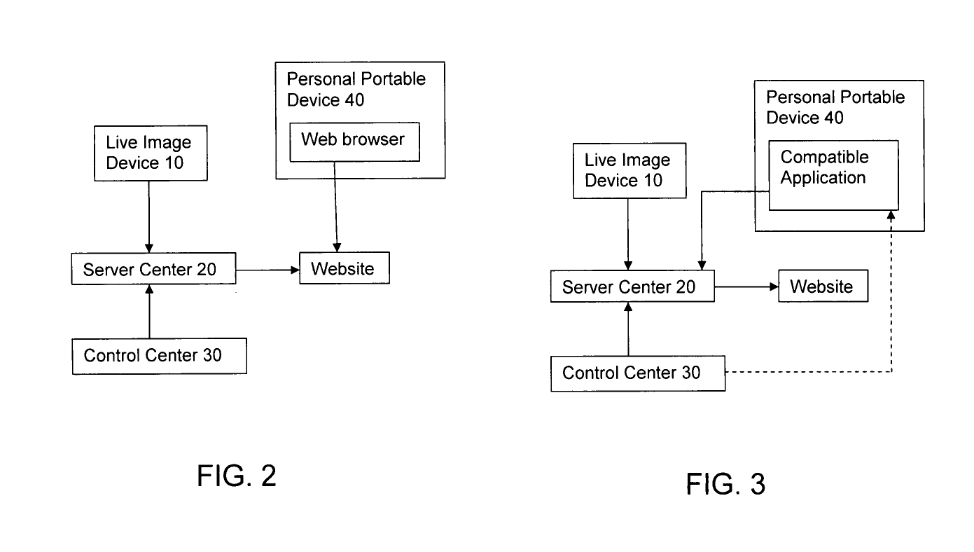

As shown in FIG. 2, through the web browser of the personal portable device 40, the personal portable device 40 is directly linked to the server center 20 via the website such that the user of the personal portable device 40 is able to select one of the live image information to be broadcasted on the web browser of the personal portable device 40. It is worth mentioning that the embed code is inputted at the website to directly link the live image information from the server center 20 to the website. Therefore, the personal portable device 40 will directly link to the server center 20 when the web browser of the personal portable device 40 is linked to the website.

As shown in FIG. 3, the control center 30 further provides the compatible application adapted for being downloaded in the personal portable device 40 to enable the personal portable device 40 being directly linked to the server centers 20. For example, an “ipad/iphone” user, the compatible application can be downloaded from the “App Store” from “Apple Company”. An “Android” user, the compatible application can be downloaded from the “Android Market”. Once the compatible application is installed into the personal portable device 40, the user thereof is able to link to the server centers 20 and to view the live image information therefrom. It is worth mentioning that the compatible application is initialized and registered to the control center 30 in order to access the live image information after the compatible application is installed into the respective personal portable device 40. Accordingly, the registering steps for the compatible application are the same as the registering steps for the control center 30 as mentioned above. Once the user is registered through the control center 30, the compatible application can be initialized by inputting the user name and password. If the user does not register to the control center 30 or is a new user, a default setting and default live image information will be configured in order to view the default live image information. It is worth mentioning that by using the compatible application, the format link 21 will be automatically configured corresponding to the compatible format of the personal portable device 40.

For example, the live image device 10 is set up at Venice Beach at California for capturing the live image of Venice beach walk and is linked to the server center 20. The control center 30 will display the live image information of the live image device 10 with the info and the embed code thereof. The user is able to “copy-and-paste” the embed code from the control center 30 to the personal website as the source code such that the live image information of the live image device 10 will be automatically displayed at the personal website. Therefore, after the embed code is copied-and-pasted at the personal website, the live image information will live-streaming from the live image device to the personal website. The user of the personal portable device 40 is able to view the live image information through the web browser by entering the personal website, such that the live image information will be live-broadcasted at the web browser of the personal portable device 40. Likewise, the user of the personal portable device 40 is able to view the live image information through the compatible application to link to the server center 20, such that the live image information will be live-broadcasted at the personal portable device 40 directly. It is worth mentioning that the live image information will be converted into the compatible format in order to display on the personal portable device 40.

In addition, all information of the live image device 10 will be shown in the selection interface, which includes the ID of the live image device 10, the user ID of the live image device 10, the IP address of the live image device 10, the RTSP port of the live image device 10, the speed rate (Bitrate in/out) of the live image device 10, and the create date of the live image device 10. The number of current view and total view of the live image device 10 will also be shown in the selection interface.

It is worth mentioning that the selection interface can be personalized by the user that only the information of the designated live image devices 10 will be shown in the selection interface. Since thousands of live image devices will be installed at different locations, the user is able to select the designated live image devices 10 in the selection interface in order to view the live image information. The user can always add or delete the live image devices 10 in the selection interface.

According to the preferred embodiment, an operation of each of the live image devices 10 can be controlled by the personal portable device 40 in an authorized manner when the respective personal portable device 40 is linked to the control center 30 through the wireless communication network.

When the personal portable device 40 is linked to the control center 30, the control center 30 will recognize whether the user of the personal portable device 40 is the owner of the live image device 10. Once the authorization is confirmed, the operation of the live image device 10 can be controlled through the personal portable device 40.

According to the preferred embodiment, the control center 30 further provides multi-functions including PTZ (Pan-Tilt-Zoom) control of the live image device 10, preset point recall, and volume control, in order to control the live image device 10 with audio steaming. Thus, the live image device 10 can be controlled with snapshot ability, snapshot image quality, record the live image information, and configure the recorded file (query, play, delete, and download) through the control center 10.

According to the preferred embodiment, the control center 30 further comprises a managing center managing the live image devices 10 in order to remotely control an operation of each of the live image devices 10 in an authorized manner through the personal portable device 40. As it is mentioned above, the live image device 10 can be controlled its PTZ (Pan-Tilt-Zoom) control, preset point recall, and volume control through the managing center. In addition, through the managing center, the user can add new live image device 10, delete current live image device 10, enable/disable the currently live image device 10, share the live image device 10 (set to share or set to privilege), check and verify software version number, check and verify the maximum connection of the live. image device 10, check current live image device 10 connected, check total live image device 10 connected, check live image device 10 bit rate, view live image streaming video, automatically check embedded source code generated by the server center 20 to be able to copy-paste to any page on any website, and check log of the server center 20.

Therefore, once the set up of the live image device 10 is completed in response to the server center 20 through the control center 30, the user of the personal portable device 40 is able to view the live image information anytime and anywhere. The live image information will broadcast directly to the users without the installation of proprietary software at the personal portable device 40. It is worth mentioning that the link between the live image device 10 and the personal portable device 40 is not a one-to-one device connection that only the owner of the live image device 10 can view the live image information by his or her personal portable device 40. The user of the personal portable device 40 is able to live-view the live image information all around the world through the establishment of the control center 30. The control center 30 allows different live image information to be posted at any website via the embed code and indexes different live image information to be broadcasted.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for transferring live images, comprising the steps of:
(a) capturing live image information by one or more live image devices, wherein said live image information is continuously transferred to one or more server centers in a live manner;
(b) communicatively linking said server centers to a control center in order to manage said live image information at said server centers; and
(c) communicatively linking one or more personal portable devices to said server centers through a wireless communication network to selectively live-broadcast said live image information to said personal portable devices.

2. The method as recited in claim 1, in the step (b), wherein each of said live image information is managed and indexed by said control center that a ID code and a privacy level are assigned and configured by said control center to each of said live image information at said server center.

3. The method as recited in claim 2, wherein said privacy level of each of said live image information is configured between a public mode that all of said live image information are accessible to be broadcasted on said personal portable device, and a private mode that said live image information is accessible to be broadcasted in an authorized manner.

4. The method, as recited in claim 1, wherein the step (c) further comprising the steps of:
(c.1) determining a compatible format of said live image information being supported by said respective personal portable device; and
(c.2) converting said live image information to said compatible format by said respective server center in order to broadcast said live image information on said personal portable device.

5. The method, as recited in claim 3, wherein the step (c) further comprising the steps of:
(c.1) determining a compatible format of said live image information being supported by said respective personal portable device; and
(c.2) converting said live image information to said compatible format by said respective server center in order to broadcast said live image information on said personal portable device.

6. The method as recited in claim 4 wherein, in the step (a), said live image information is captured in RTSP format.

7. The method as recited in claim 5 wherein, in the step (a), said live image information is captured in RTSP format.

8. The method as recited in claim 1, in the step (c), wherein said personal portable device is directly linked to said respective server center via a web browser of said personal portable device.

9. The method as recited in claim 3, in the step (c), wherein said personal portable device is directly linked to said respective server center via a web browser of said personal portable device.

10. The method as recited in claim 7, in the step (c), wherein said personal portable device is directly linked to said respective server center via a web browser of said personal portable device.

11. The method as recited in claim 1, in the step (c), wherein said personal portable device is linked to said respective server center via an application downloaded to said personal portable device.

12. The method as recited in claim 3, in the step (c), wherein said personal portable device is directly linked to said respective server center via a compatible application downloaded to said personal portable device.

13. The method as recited in claim 7, in the step (c), wherein said personal portable device is directly linked to said respective server center via a compatible application downloaded to said personal portable device.

14. The method as recited in claim 11, wherein the step (c) further comprises a step of registering said compatible application to said control center in order to access said live image information after said compatible application is installed into said respective personal portable device.

15. The method as recited in claim 12, wherein the step (c) further comprises a step of registering said compatible application to said control center in order to access said live image information after said compatible application is installed into said respective personal portable device.

16. The method as recited in claim 13, wherein the step (c) further comprises a step of registering said compatible application to said control center in order to access said live image information after said compatible application is installed into said respective personal portable device.

17. The method, as recited in claim 1, further comprising a step of controlling an operation of each of said live image devices by said respective personal portable device in an authorized manner when said respective personal portable device is linked to said control center through said wireless communication network.

18. The method, as recited in claim 10, further comprising a step of controlling an operation of each of said live image devices by said respective personal portable device in an authorized manner when said respective personal portable device is linked to said control center through said wireless communication network.

19. The method, as recited in claim 16, further comprising a step of controlling an operation of each of said live image devices by said respective personal portable device in an authorized manner when said respective personal portable device is linked to said control center through said communication network.

20. A live image system for transferring live images to personal portable devices, comprising:
one or more live image devices located at different locations for capturing live image information;
one or more server centers communicatively linked to said live image devices for receiving said live image information from said live image device, wherein said live image information is continuously transferred to said respective server center in a live manner; and
a control center communicatively linked to said server centers in order to manage said live image information at said server centers, wherein each of said server centers is arranged for communicatively linking said personal portable devices through a wireless communication network to selectively live-broadcast said live image information to said personal portable devices.

21. The system, as recited in claim 20, wherein each of said live image information is managed and indexed by said control center that an ID code and a privacy level are assigned and configured by said control center to each of said live image information at said server center.

22. The system, as recited in claim 21, wherein said privacy level of each of said live image information is configured between a public mode that all of said live image information are accessible to be broadcasted on said personal portable device, and a private mode that said live image information is accessible to be broadcasted in an authorized manner.

23. The system, as recited in claim 20, wherein each of said server centers comprises a format link for determining a compatible format of said live image information being supported by said respective personal portable device, and a format converter for converting said live image information in RTSP format to said compatible format in order to broadcast said live image information on said personal portable device.

24. The system, as recited in claim 22, wherein each of said server centers comprises a format link for determining a compatible format of said live image information being supported by said respective personal portable device, and a format converter for converting said live image information in RTSP format to said compatible format in order to broadcast said live image information on said personal portable device.

25. The system, as recited in claim 20, wherein each of said server centers is accessible through a web browser of said personal portable device in order to broadcast said live image information to said web browser of said personal portable device.

26. The system, as recited in claim 24, wherein each of said server centers is accessible through a web browser of said personal portable device in order to broadcast said live image information to said web browser of said personal portable device.

27. The system, as recited in claim 20, wherein said control center comprises a compatible application adapted for being downloaded in said personal portable device to enable said personal portable device being directly linked to said server centers.

28. The system, as recited in claim 24, wherein said control center comprises a compatible application adapted for being downloaded in said personal portable device to enable said personal portable device being directly linked to said server centers.
